(19) United States
(12) Patent Application Publication
(10) Pub. No.: US 2011/0099488 A1
(43) Pub. Date: Apr. 28, 2011

(54) METHOD AND APPARATUS FOR PRESENTING VIDEO ASSETS

(75) Inventors: Zhiying Jin, Lexington, MA (US); Wenjie Liu, Wayland, MA (US); Juhong Liu, Sudbury, MA (US); Haosheng Guo, Nashua, NH (US); Haiyan Zhou, Waltham, MA (US)

(73) Assignee: VERIZON PATENT AND LICENSING INC., Basking Ridge, NJ (US)

(21) Appl. No.: 12/605,551

(22) Filed: Oct. 26, 2009

(51) Int. Cl. G06F 17/30; G06F 3/048

(52) U.S. Cl. 715/764; 707/723; 707/E17.017

(57) ABSTRACT

An approach is provided for presenting video assets. An asset manager determines a plurality of factors for positioning of video assets represented on a graphical user interface. The asset manager then determines weighting of the factors using one or more rules that are based on a search operation or a browse operation relating to the assets. From the determined plurality of factors and weighting of the factors, the asset manager computes a score for ranking of a particular one of the assets with respect to the positioning of other ones of the assets.

### BACKGROUND INFORMATION

With the advent of computers, interactive electronic communications, and the Internet, as well as advances in the digital realm of consumer information, has come a reinvention of conventional entertainment and communication services to enhance programming, recording, and viewing of multimedia, such as broadcast television programs. Today, it is not uncommon for consumers to have access to hundreds, if not thousands, of video assets (e.g., media programs, programming content, etc.) from a multitude of sources such as broadcast television, on-demand programming, and other third party content providers available through the Internet. However, while the programming choices available to consumers have progressed, the way consumers access and view those choices have not kept pace. In many cases, a consumer has to sift through potentially thousands of programs to discover programs of interest. As a result, the consumer often is either unable to find or cannot easily find the programs the consumer wants to view.

Therefore, there is a need for an approach for presenting video assets to facilitate discovering video assets of interest.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of presenting video assets, according to an exemplary embodiment;

FIG. 2 is a diagram of a set-top box configured to present video assets, according to an exemplary embodiment;

FIG. 3 is a diagram of a main menu user interface of the set-top box of FIG. 2, according to an exemplary embodiment;

FIG. 4 is a flowchart of a process for ranking and presenting video assets, according to an exemplary embodiment;

FIG. 5 is a flowchart of a process for presenting video assets based on user-specified weighting values, according to an exemplary embodiment;

FIGS. 6A and 6B are diagrams of user interfaces utilized in the process of FIGS. 4-5, according to various embodiments;

FIG. 7 depicts a user interface for specifying factors and weighting values for ranking video assets, according to an exemplary embodiment; and

FIG. 8 is a diagram of a computer system that can be used to implement various exemplary embodiments.

### DESCRIPTION OF THE PREFERRED EMBODIMENT

A preferred apparatus, method, and system for presenting video assets are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to video assets that are on-demand content (e.g., video-on-demand (VOD) content provided at the request of a user), it is contemplated that these embodiments have applicability to any type of video asset or content including traditional television programming (e.g., “over-the-air” programming, cable programming, satellite programming, etc.) as well as online content (e.g., network-streamed content, on-demand content, Internet programming, media-sharing websites, etc.).

In addition, the exemplary embodiments are described with respect to a set-top box (STB), but also have applicability to any device capable of processing audio-video (AV) signals for presentation to a user, such as a home communication terminal (HCT), a digital home communication terminal (DHCT), a stand-alone personal video recorder (PVR), a television set, a digital video disc (DVD) player, a video-enabled phone, an AV-enabled personal digital assistant (PDA), and/or a personal computer (PC), as well as other like technologies and customer premises equipment (CPE).

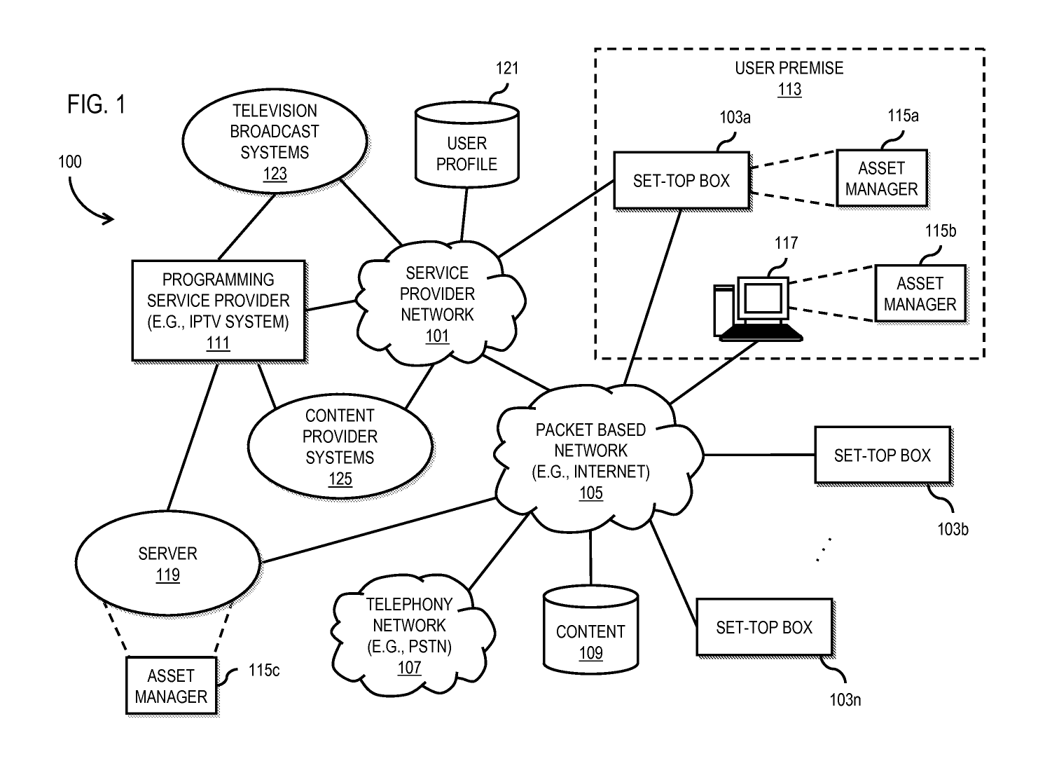

FIG. 1 is a diagram of a system capable of presenting video assets, according to an exemplary embodiment. It is observed that even with the advent of the Internet and high-speed data connections, television remains the prevalent global medium for entertainment and information. For example, television users continue to be presented with an ever increasing amount and variety of programming choices (e.g., video assets). It is not uncommon for television users to have access to hundreds of programming channels dedicated to any of a number subjects. In fact, as traditional television programming (e.g., “over-the-air” programming, cable programming, satellite programming, etc.) merges with the online content (e.g., network-streamed content, on-demand content, Internet programming, media-sharing websites, etc.), the available programming choices are likely to continue to explode. For example, internet protocol television (IPTV) service providers are currently offering subscribers various video services ranging from multi-channel video programming that mimics traditional broadcast television, to true video-on-demand (VOD) programming. These services are further supplemented with interactive video applications that enable robust programming content, selection and navigation functionality, as well as integrated digital video recording, and data services to enhance the video experience. These shared protocols create integrated value propositions with regard to accessible content.

Historically, users have relied on programming guides or simple searches to navigate through available programming and content (e.g., video assets). These guides and search results generally list programming content by, for instance, channel, date, and time. As a result, finding a specific program from among the myriad of available programs using a traditional programming guide and/or search can be difficult and cumbersome, particularly as the number of programs grows. Thus, it is apparent that improvements are needed to provide consumers with the ability to experience the programming content they want, at any time they desire, using those devices designed to maximize the multimedia experience.

To address this problem, the system 100 of FIG. 1 enables the automatic presentation and positioning of video assets by determining which of the video assets may be of most interest to the user based on factors such as the price for viewing the video asset, relevancy of the video asset to the user's search, active date of the video asset, popularity of the video asset, or a combination thereof. It is contemplated that the programming provider or other service provider may specify any of the listed factors or other similar factors for calculating the positioning or order of video assets to be presented to the user. More specifically, the system 100 applies one or more of the factors to determine the positioning of video assets in a graphical user interface that is presented to a user. The determination is based in part on weighting values specified for each of the factors using one or more rules that are based on the type of operation or command (e.g., search or browse) used to invoke the graphical user interface containing the video assets. The factors and their associated weighting are then used to compute a score for ranking the video assets. This ranking then determines the positioning of the video assets in the graphical user interface.

As shown in FIG. 1, the system 100 can be configured to present video assets according to specified factors over a service provider network 101. By way of example, the programming content available over the service provider network 101 may include any audio-visual content (e.g., broadcast television programs, digital video recorder (DVR) content, on-demand programs, pay-per-view programs, IPTV (Internet Protocol Television) feeds, DVD related content, etc.), pre-recorded media content, data communication services content (e.g., commercials, advertisements, videos, movies, songs, audio books, etc.), Internet-based content (e.g., streamed video, streamed audio), and/or any other equivalent media form. In one embodiment, the graphical user interface of video assets is presented according to one or more criteria (e.g., search criteria, browse criteria) specified by, for instance, a user of a set-top box (STB) (e.g., STB 103a). It is contemplated that the criteria may also be implicitly specified by, for instance, monitoring the viewing or recording habits of user of the STB. For example, determining the ranking and positioning of video assets in the graphical user interface enables the system 100 to filter content from the general all-encompassing programming guide to present the user with those programs that are more likely to be of interest to the user. It is contemplated that system 100 may embody many forms and include multiple and/or alternative components and facilities.

In the example of FIG. 1, service provider network 101 integrates the television medium with that of the telecommunications, computing, and media environments, thereby broadening the scope of devices and sources available to individuals for obtaining programming content or video assets. In this manner, system 100 relieves network operators from the burden and expense of providing parallel avenues to content, by enabling users, via user equipment (e.g., STB 103a), to receive programming content accessible over traditional transmission systems (e.g., broadcast, cable, satellite, fiber optic cable) as well as over a data network (e.g., packet-based network 105). Although the user equipment is described with respect to an STB 103, it is contemplated that various embodiments have applicability to any device capable of processing video, audio, and/or multimedia streams.

In a typical scenario, an individual (e.g., a subscriber of the service provider network 101) may establish a link between a data network source (e.g., content repository 109) and a programming service provider 111 to search or browse content to generate a graphical user interface presenting video assets according to the ranking of each of the video assets. The graphical user interface is then experienced at a user premise 113 via an STB (e.g., STB 103a). By way of example, the video assets may be delivered or transmitted over any appropriate mechanism including delivery via in-band adjacent-channels to conventional video broadcasting channels, such as multicast (e.g., live television) or unicast (e.g., stored video) streams. Other implementations may provide programming content on a sideband, in the vertical blanking interval, as a sub-channel, or using out-of-band signals, as well as any other suitable transmission technique. In this regard, the graphical user interface of ranked video assets may provide a directory of content accessible over any number of analog or digital channels offered to subscribers at any suitable frequency or rate (e.g., continuously, periodically, on-demand, etc.). In addition or alternatively, the personalized programming guide may include content that is resident, stored, or recorded on the STB (e.g., STB 103a).

An asset manager application (e.g., asset manager 115a) enables users to easily, effectively, and intuitively browse and/or search video assets to generate a graphical user interface of ranked video assets for programming content accessible over the service provider network 101 or the data network 105. In other embodiments, one or more asset manager applications 115a-115c may enable content specified in the graphical user interface to be retrieved and presented to a user via the STB (e.g., STB 103a). Still further, asset manager applications 115a-115c may enable users to create personalized rankings of video assets and make the rankings available to other subscribers, i.e., to share personalized rankings of video assets with another STB (e.g., STBs 103b-103n). As such, embodiments of the service provider network 101 may also enable individuals utilizing STBs to interact with one another, through personalized communications channels, to further facilitate the processes described herein.

As discussed previously, video assets or programming content broadly includes any audio-visual content (e.g., broadcast television programs, VOD programs, pay-per-view programs, IPTV feeds, DVD related content, etc.), pre-recorded media content, data communication services content (e.g., commercials, advertisements, videos, movies, songs, images, sounds, etc.), Internet services content (streamed audio, video, or pictographic media), and/or any other equivalent media form. In this manner, the programming service provider 111 may provide (in addition to the provider's own programming content) content obtained from other sources, such as one or more television broadcast systems 123, one or more third-party content provider systems 125, content residing in a repository 109 or accessible via server 119, as well as available via one or more packet-based networks 105 or telephony networks 107, etc.

Programming service provider 111 can provide content that is retrieved over the packet-based network 105, as well as provide conventional media streams. For instance, programming service provider 111 may provide “virtual channels” to content traditionally limited to host sites, such as end user originated content uploaded to audio, video, and/or pictographic sharing sites. Additionally, the programming content may include streamed audio and/or video from conventional broadcast providers. It is noted that programming content can be any type of information provided from any source having connectivity to system 100.

In this manner, asset manager applications 115a and 115b may be executable, for example, as one or more user interfaces capable of local implementation on an STB (e.g., STB 103a-103n) or on an end terminal 117, such as a computer, telephony device, mobile device, or other like mechanism. Thus, exemplary embodiments of asset manager applications 115a and 115b may be provided through navigation shell applications, e.g., menu applications having options corresponding to different functions. By way of example, computer devices may include desktop computers, notebook computers, servers, terminal workstations, gaming systems, customized hardware, or other equivalent apparatus. Telephony devices may comprise plain-old-telephones, wireless telephones, cellular telephones, satellite telephones, voice over internet protocol telephones, and the like. Mobile devices may include personal digital assistants (PDA), pocket personal computers, smart phones, tablets, handsets, portable gaming systems, and customized hardware, as well as other mobile technologies capable transmitting data. Moreover, STBs 103a-103n may be used alone or in combination with one or more end terminal(s) 117 to implement various exemplary embodiments.

The STBs 103a-103n and/or terminal 117 can communicate using the packet-based network 105 and/or the telephony network 107. These systems can include: a public data network (e.g., the Internet), various intranets, local area networks (LAN), wide area networks (WAN), the public switched telephony network (PSTN), integrated services digital networks (ISDN), other private packet switched networks or telephony networks, as well as any additional equivalent system or combination thereof. These networks may employ various access technologies including cable networks, satellite networks, subscriber television networks, digital subscriber line (DSL) networks, optical fiber networks, hybrid fiber-coax networks, worldwide interoperability for microwave access (WiMAX) networks, wireless fidelity (WiFi) networks, other wireless networks (e.g., 3G wireless broadband networks, mobile television networks, radio networks, etc.), terrestrial broadcasting networks, provider specific networks (e.g., a Verizon® FiOS® network, a TiVo network, etc.), and the like. Such networks may also utilize any suitable protocol supportive of data communications, e.g., transmission control protocol (TCP), internet protocol (IP), file transfer protocol (FTP), telnet, hypertext transfer protocol (HTTP), asynchronous transfer mode (ATM), socket connections, Ethernet, frame relay, and the like, to connect STBs 103a-103n to various sources of media content. Although depicted in FIG. 1 as separate networks, packet-based network 105 and/or telephony network 107 may be completely or partially contained within service provider network 101. For example, service provider network 101 may include facilities to provide for transport of packet-based and/or telephony communications.

By way of example, STB 103a-103n, as well as terminal 117, can remotely access one or more servers (e.g., server 119), via a communication interface (not illustrated), configured to execute multiple instances of asset manager application 115c. That is, asset manager application 115c may be provided in a distributed fashion using, for instance, client-server architectures, such as implemented by enterprise application service providers (ASP). It is noted that ASP models (and other like architectures) offer system scalability in terms of administrative scalability, geographic scalability, and/or load scalability. Thus, distributed environments are attractive modes for disseminating system 100 functionality to a broad spectrum of users and devices.

For example, server 119 can be an “online” system capable of communicating with one or more third-party web servers (not illustrated), content repositories (e.g., repository 109), or equivalent facilities, to provide users various avenues to locate, specify, receive, and/or share programming content that is accessible over a data network (e.g., packet-based network 105). For example, exemplary embodiments of asset manager application 115c may comprise hypertext markup language (HTML) user interfaces or JAVA™ applets stored on server 119 and accessed via world-wide-web pages. These interfaces are particularly useful in extending system 100 functionality to devices having limited resources (e.g., PDAs, handsets, thin-clients, etc.). In alternative embodiments, server 119 is collocated with and/or integrated into programming service provider 111. As such, multiple users, interfaces, and instances of asset manager application 115c can be simultaneously realized through system 100.

In the example of FIG. 1, STBs 103a-103n are located at one or more user premises (e.g., user premise 113), and geospatially associated with one or more regions. STBs 103a-103n may be configured to communicate with and receive signals and/or data streams from a programming service provider 111 (or other transmission facility) in response to processes of one or more asset manager application(s) 115a-115c. These signals include results of applying search or browse operations on the available programming content (e.g., video assets) and related date (e.g., programming guide data, metadata) retrieved over a data network (e.g., service provider network 101, packet-based network 105, and/or telephony network 107), as well as conventional video broadcast content.

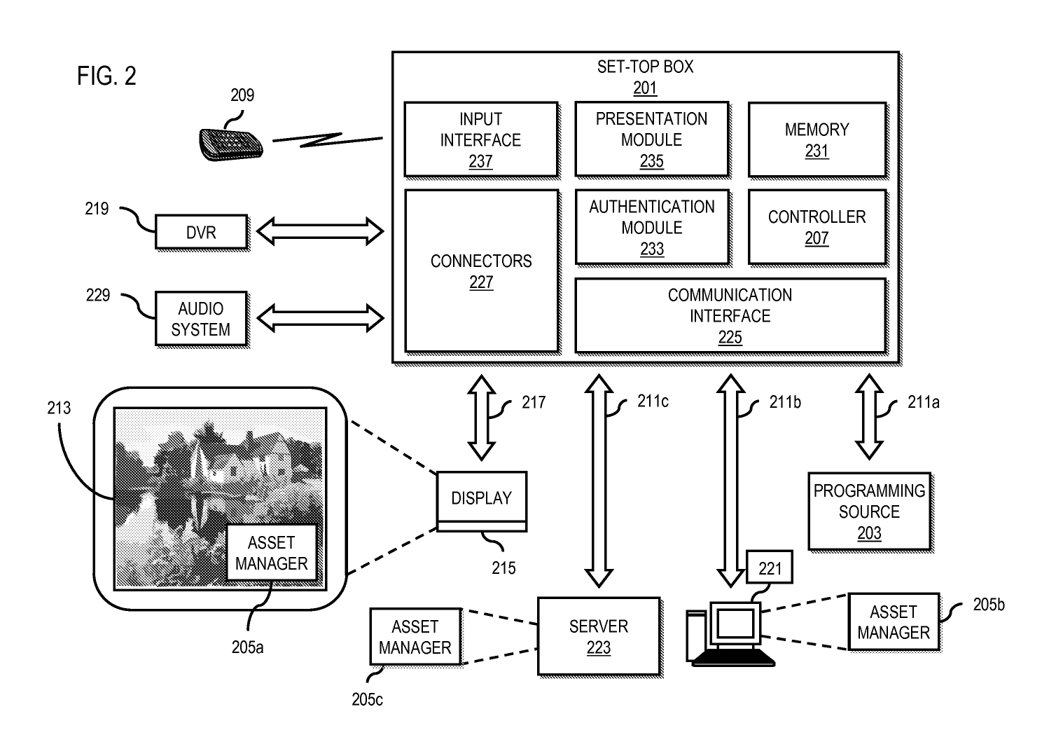

Programming service provider 111 can include one or more programming content servers (not illustrated) and/or data repositories (not shown). Alternatively, user profile repository 121, content repository 109, or server 119 may be accessed via one or more service provider networks 101 and/or packet-based networks 105. In one embodiment, the user profile repository 121 stores user settings, preferences, and configuration information for the asset manager 115a. Further, service provider network 101 may include a system administrator (not shown) for operational and management functions to deploy the virtual channel service using, for instance, an internet protocol television (IPTV) system. In this manner, STBs 103a-103n can utilize any suitable technology to draw, receive, and/or transmit media content from/to a programming service provider 111 or other content source/sink. A more detailed explanation of an exemplary STB is provided with respect to FIG. 2.

In an exemplary embodiment, STBs 103a-103n can draw, receive, and/or transmit programming guide information and related content from (or to) multiple sources, thereby alleviating the burden on any single source, e.g., programming service provider 111, to gather, supply, or otherwise meet the content demands of any user or premise. Thus, particular embodiments enable authenticated third-party television broadcast systems 123, third-party content provider systems 125, and servers (e.g., server 119) to transmit programming content accessible over a data network to STBs 103a-103n either apart from, or in conjunction with, programming service provider 111. Such programming content may include content regarding traffic, news, sports, current events, breaking stories, commentary, headlines, advertisements, solicitations, financial advice, stocks, markets, events, schools, governments, blog entries, podcasts, and the like. Moreover, media content may be available from authenticated sources, including grassroots groups or individuals, non-profits, governmental organizations, public/private institutions, etc.

The programming content may be distinguished (or otherwise categorized) utilizing metadata included therewith or appended thereto. Metadata can be generally considered data about data; but more specifically, it can be utilized to describe all aspects of, and programming content distributed by, system 100. Namely, metadata can include descriptions about: data aspects (file name, type, administrator, size, location, version, or include timestamps, mode bits, arbitrary attribute-value pairs, etc.), titles, activities/events, individuals and organizations involved, intended audiences (e.g., ethnicities, ages, genders, incomes, educational levels, disabilities, mobilities, as well as other like demographic statistics), geospatial identifications (intended zip codes, school districts, communities, etc.), locations of supplementary information and processes, access methods, limitations, timing of activities/events (e.g., start/end dates), as well as motivations, policies and rules. As such, metadata may be utilized by various components of system 100 for control and/or ranking purposes. In particular embodiments, system 100 may structure and encode metadata to describe characteristics of the content-bearing entities to aid in the identification, discovery, assessment, and management of the programming content by asset manager applications 115a-115c. For example, the asset manager 115a may apply retrieved information from the metadata corresponding to the factors the asset manager 115a is using to determine the relative positioning of the video assets in a graphical user interface.

In addition or alternatively, the metadata can be used to optimize compression algorithms or perform other computational tasks by the components of system 100. The metadata might be utilized to share personalized rankings of video assets among a plurality of STBs 103a-103n. Various other embodiments might use metadata to suggest criteria for creating personalized programming guides of content sources that may be of interest to a user based on information stored in a user profile. A more detailed explanation of user profiles is provided with respect to FIG. 2.

In various embodiments, service provider network 101 may include one or more video and/or audio processing modules (not shown) for acquiring and transmitting programming guide information and related content feeds (including content accessible over a data network) from programming service provider 111, the television broadcast systems 123, the third-party content provider systems 125, or servers 119 over one or more of the networks 101, 105, 107, to particular STBs 103a-103n. Accordingly, service provider network 101 may include facilities to support compression/decompression, coding/decoding, modulation/demodulation, optical/electrical conversion, and analog/digital conversion, as well as any other suitable signal processing and/or transmission operation. Further, service provider network 101 can optionally support end-to-end data encryption in conjunction with programming guide creation and related content streaming services such that only authorized users are able to access personalized programming guides and experience content reference therein.

Accordingly, system 100 may include an authentication module (not shown) configured to perform authorization/authentication services and determine whether users or content sources are indeed subscribers to, or providers of, the personalized programming guide service. An authentication schema may require a user name and password, a key access number, a unique machine identifier (e.g., media access control (MAC) address), etc., as well as a combination thereof. Once a subscriber has authenticated a presence on system 100, the user may bypass additional authentication procedures for executing later applications (e.g., programming content streaming instances). Data packets, such as cookies, may be utilized for this purpose. Thus, once an STB or content source is authenticated, connections between the STBs 103a-103n and the content sources may be established directly or through the programming service provider 111.

In other embodiments, authentication procedures on a first device (e.g., STB 103a) may identify and authenticate a second device (e.g., terminal 117) communicatively coupled to, or associated with, the first device. Further, the authentication module may grant users the right to receive programming guide information and related content from multiple system 100 sources by revoking existing sets of digital certificates associated with a particular provider, and issuing new sets of digital certificates mapped to a second provider. In this regard, an STB (e.g., STB 103a) may receive new programming content or guide information from a second source, whereas the previous session may be automatically closed when the “old” or prior certificates associated with the first source are revoked. This enables users to initiate secure sessions at any given STB 103a-103n (or end terminal 117) linked to system 100, whether or not the STB (or end terminal) belongs to that individual user. It is additionally contemplated that multiple rights sessions may exist concurrently.

In particular embodiments, programming service provider 111 may comprise an IPTV system configured to support the transmission of television video programs from the broadcast systems 123 as well as other content, such as content from the various third-party sources (e.g., 109, 119, 123, 125) utilizing internet protocol (IP). That is, the IPTV system 111 may deliver programming guide information, signals and/or streams, including programming content accessible over a data network, in the form of IP packets. Further, the transmission network (e.g., service provider network 101) may optionally support end-to-end data encryption in conjunction with the streaming services, as previously mentioned.

In this manner, the use of IP permits television services to be integrated with broadband Internet services, and thus, share common connections to a user site. Also, IP packets can be more readily manipulated, and therefore, provide users with greater flexibility in terms of control and offers superior methods for increasing the availability of programming guide information and related content. Delivery of video content, by way of example, may be through a multicast from the IPTV system 111 to the STBs 103a-103n. Any individual STB may tune to a particular content source by simply joining a multicast (or unicast) of the media content, utilizing an IP group membership protocol (IGMP). For instance, the IGMP v2 protocol may be employed for joining STBs to new multicast (or unicast) groups. Such a manner of content delivery avoids the need for expensive tuners to view media content, such as television broadcasts; however, other delivery methods, such as directly modulated carriers (e.g., national television systems committee (NTSC), advanced television systems committee (ATSC), quadrature amplitude modulation (QAM)), may still be utilized. It is noted that conventional delivery methods may also be implemented and combined with the advanced methods of system 100. Further, the programming content may be provided to various IP-enabled devices, such as those computing, telephony, and mobile apparatuses previously delineated.

An STB (e.g., STB 103a) may integrate all the functions of an IPTV system, as well as combine the programming content and video asset management functions of the various online or off-line environments. For example, it is contemplated that the personalized programming guide service may be extended to users with a presence on the Internet. In alternative embodiments, the services of system 100 could be extended to users having an end terminal (not shown), such as a plain old telephone service (POTS) device, connected to the telephony network 107. While system 100 is illustrated in FIG. 1, the exemplary components are not intended to be limiting, and indeed, additional or alternative components and/or implementations may be utilized.

In one embodiment, the video asset management service is a managed service, whereby a service provider operates the asset manager 115a and system 100 to serve one or more subscribers.

FIG. 2 is a diagram of a set-top box configured to present video assets in graphical user interface, according to an exemplary embodiment. STB 201 may comprise any suitable technology to receive one or more content streams (e.g., video assets) from a media source 203, such as the IPTV system of FIG. 1. The content streams include programming guide information and related metadata retrieved over the service provider network 101, in response to commands from one or more asset manager application(s) 205a-205c, for presentation via STB 201. The STB 201 may then apply the guide information and/or related metadata as factors for determining the ranking for presenting the corresponding video assets in the graphical user interface. In one embodiment, the rules for applying the factors are determined by the type of operation or command used to invoke the graphical user interface of video assets. For example, if the user performs a search query, the system 100 may apply one set of rules for applying the factor; if the user performs a browse operation for video assets, the system 100 may apply another set of rules. The rules, for instance, specify the factors and relative weighting of each factor that is to be used to rank the video assets for presentation in the graphical user interface.

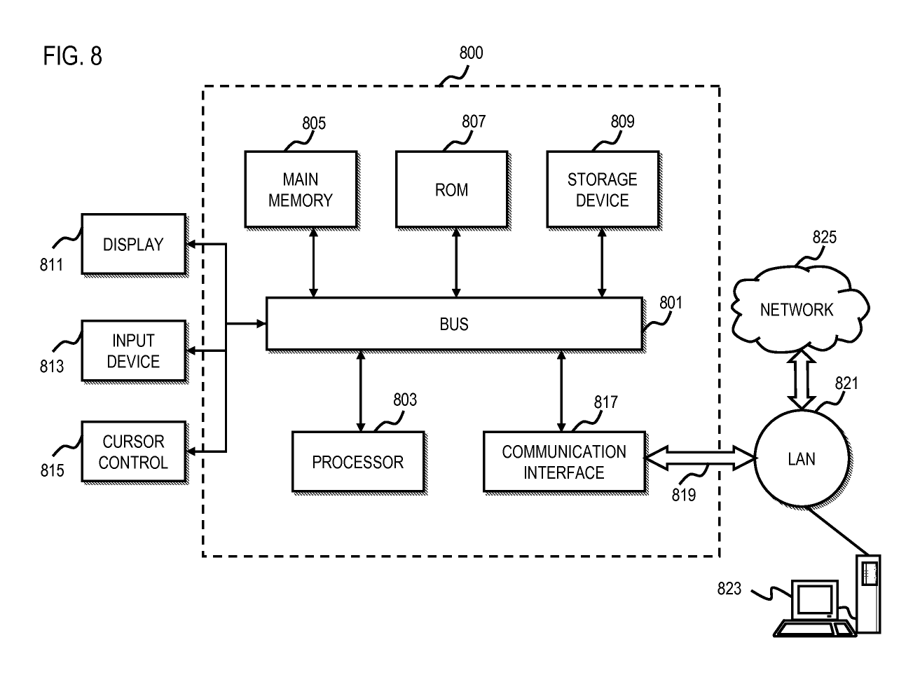

Accordingly STB 201 may comprise computing hardware (such as described with respect to FIG. 8) and include additional components configured to provide specialized services related to the ranking and presentation of video assets in a graphical user interface. In addition, STB 201 includes hardware and/or other components to support related functions and capabilities for viewing video assets (e.g., remote control capabilities, conditional access functions, tuning functions, presentation functions, multiple network interfaces, audio/video signal ports, etc.). As shown in FIG. 2, the functions and operations of STB 201 may be governed by a controller 207 that interacts with each of the STB components to provide programming guide information and related content retrieved from an audio or video-sharing site, as well as from another STB device or component of system 100. In turn, the user may be afforded greater functionality utilizing a control device 209 to control the personalized programming guide service and related services, as will be more fully described below.

As such, STB 201 may be configured to rank video assets for presentation in graphical user interface and present related content streams (e.g., streams 211a-211c), including causing an asset manager application 205a and/or one or more components of the graphical user interface of ranked video assets and the media content referenced therein (e.g., video component 213 and/or an audio component) to be presented on (or at) display 215. Presentation of the graphical user interface of ranked video assets and related content may include: displaying, recording, playing, rewinding, forwarding, toggling, selecting, zooming, or any other processing technique that enables users to navigate the programming guide and experience content streams 211a-211c. For instance, STB 201 may provide one or more signals 217 to a display 215 (e.g., television) so that the display 215 may present (e.g., display) the graphical user interface of ranked video assets created by the asset manager application 205a as an overlay on the programming content (e.g., video 213).

In one embodiment, the graphical user interface of ranked video assets is displayed in the same manner as the general programming guide (e.g., as a grid or list) with the exception that the position of the video assets is determined according to the determined rankings of the video assets. In other words, the graphical user interface of ranked video assets displays those video assets that are more likely to be of interest to the user in a first or more prominent location of the graphical user interface to enable the user to more quickly find and discover programs of interest. In addition or alternatively, the asset manager application 205a may present the graphical user interface of ranked video assets as one or more “virtual channels” whereby the ranking results are displayed in the programming guide as if the results constitute a separate programming channel listed in the programming guide. In either case, the asset manager application 205a can dynamically update the programming content displayed in the graphical user interface of ranked video assets as the user navigates through the list or grid of video assets.

STB 201 may also interact with a PVR, such as digital video recorder (DVR) 219, to store received content that can then be manipulated by a user at a later point in time. In various embodiments, DVR 219 may be network-based, e.g., included as a part of the service provider network 101, collocated at a subscriber site having connectivity to STB 201, and/or integrated into STB 201. A display 215 may present a graphical user interface of ranked video assets and related content provided via STB 201 to a user. In alternative embodiments, STB 201 may be configured to communicate with a number of additional peripheral devices, including: a PC 221, laptops, PDAs, cellular phones, monitors, mobile devices, handheld devices, as well as any other equivalent technology capable of presenting programming guide information and related content to a user, such as those computing, telephony, and mobile apparatuses described with respect to FIG. 1.

These peripherals may be configured to implement instances of an asset manager application (e.g., asset manager application 205b) to access programming guide information and related content stored and/or processed by STB 201. For example, a programming content stream 211a may be received by STB 201 and recorded by DVR 219, wherein PC 221 may later access and view the stored content. In one embodiment, this stored content may be included in the list of video assets available for ranking by the assent manager application 205b. Moreover, the peripheral devices may be configured to program or otherwise control the functions of STB 201. For instance, the asset manager application 205b executed on PC 221 may receive input from a user specifying display or creation of a graphical user interface of ranked video assets for the content that is accessible over a data network. A communication interface (not illustrated) of PC 221 may be configured to retrieve the programming and content information over the data network (e.g., packet-based network 105), wherein STB 201 may receive a programming content stream 211b from PC 221 to present to the user via display 215.

In another embodiment, user input to STB 201 and/or a peripheral device (e.g., PC 221) executing an instance of an asset manager application (e.g., asset manager application 205a and/or 205b) may cause a specified ranking of video assets and/or related content to be made available at another STB (e.g., STB 103b-103n) or a computing, telephony, or mobile device capable of processing audio and/or video streams. Still further, user input to a network-based asset manager application 115c, implemented on, for instance, server 223, may be configured to create a personalized programming guide or otherwise control the functions of STB 201. For instance, a user may access asset manager application 115c via an end terminal 117 (e.g., PC 221, a mobile handset, etc.), over one or more data networks (e.g., network 101, 105, and/or 107), to locate, specify, share, and/or transmit video asset ranking information and related content to STB 201. In this manner, server 221 (or other component of system 100, such as programming service provider 111) may, when suitable, transmit specified ranking information and related content as stream 211c to STB 201 for presentation at display 215.

Furthermore, STB 201 may include a communication interface 225 configured to receive content streams from the programming service provider 111, PC 221, server 223, or other programming content source, such as media source 203. Communication interface 225 may optionally include single or multiple port interfaces. For example, STB 201 may establish a broadband connection to multiple sources transmitting content to STB 201 via a single port, whereas in alternative embodiments, multiple ports may be assigned to the one or more sources. In still other embodiments, communication interface 225 may be configured to permit users, via STB 201, to transmit data (including media content) to other users with STBs, a programming service provider 111, or other content source/sink.

According to various embodiments, STB 201 may also include inputs/outputs (e.g., connectors 227) to display 215 and DVR 219, as well as an audio system 229. In particular, audio system 229 may comprise a conventional audio-video receiver capable of monaural or stereo sound, as well as multichannel surround sound. Audio system 229 may include speakers, ear buds, headphones, or any other suitable component configured for personal or public dissemination. As such, STB 201, display 215, DVR 219, and audio system 229, for example, may support high resolution audio and/or video streams, such as high definition television (HDTV) or digital theater systems high definition (DTS-HD) audio. Thus, STB 201 may be configured to encapsulate data into a proper format with required credentials before transmitting onto one or more of the networks of FIG. 1 and de-encapsulate incoming traffic to dispatch data to display 215 and/or audio system 229.

In an exemplary embodiment, display 215 and/or audio system 229 may be configured with internet protocol (IP) capability (i.e., includes an IP stack, or is otherwise network addressable), such that the functions of STB 201 may be assumed by display 215 and/or audio system 229. In this manner, an IP ready, HDTV display or DTS-HD audio system may be directly connected to one or more service provider networks 101, packet-based networks 105, and/or telephony networks 107. Although STB 201, display 215, DVR 219, and audio system 229 are shown separately, it is contemplated that these components may be integrated into a single component, or other combination of components.

An authentication module 233 may be provided at STB 201 to initiate or respond to authentication schemes of, for instance, service provider network 101 or various other content providers, e.g., broadcast television systems 123, third-party content provider systems 125, or servers 119. Authentication module 233 may provide sufficient authentication information, e.g., a user name and password, a key access number, a unique machine identifier (e.g., MAC address), and the like, as well as combinations thereof, to a corresponding network interface for establishing connectivity. As described earlier, one or more digital certificates may be simultaneously mapped. Moreover, authentication at STB 201 may identify and authenticate a second device (e.g., PC 221) communicatively coupled to, or associated with, STB 201, or vice versa. Further, authentication information may be stored locally at memory 231, in a repository (not shown) connected to STB 201, or at a remote repository, e.g., user profile repository 121.

Authentication module 233 may also facilitate the reception of data from single or disparate sources. For instance, STB 201 may receive broadcast video from a first source (e.g., IPTV system 111), signals from an asset manager application at second source (e.g., server 119), and a programming content stream from a third source accessible over a data network (e.g., content repository 109). As such, display 215 may present the broadcast video, asset manager application, and programming content stream to the user. This presentation may be experienced separately, concurrently, in a toggled fashion, or with zooming, maximizing, minimizing, or trick capabilities, or equivalent mode. In other exemplary embodiments, authentication module 233 can authenticate a user to allow them to specify a personalized graphical user interface of ranked video assets and related content that is to be presented to other STBs (e.g., STB 103a-103n).

A presentation module 235 may be configured to receive data streams 211a-211c (e.g., audio/video feed(s) including video asset ranking information and related content retrieved over the service provider network 101) and output a result via one or more connectors 227 to display 215 and/or audio system 229. In this manner, presentation module 235 may also provide a user interface for asset manager application 205a via display 215. Aural aspects of asset manager application 205a (e.g., audible alerts and cues) may be presented via audio system 229 and/or display 215. In certain embodiments, asset manager application 205a may be overlaid on the video content output 213 of display 215 via presentation module 235.

Connector(s) 227 may provide various physical interfaces to display 215, audio system 229, as well as other peripherals; the physical interfaces may include, for example, RJ45, RJ11, high definition multimedia interface (HDMI), optical, coax, FireWire, wireless, and universal serial bus (USB), or any other suitable connector. The presentation module 235 may also interact with a control device 209 for determining particular media content that a user desires to experience. In an exemplary embodiment, the control device 209 may comprise a remote control (or other access device having control capability, such as a PC 221, wireless device, mobile phone, etc.) that provides a user with the ability to readily manipulate and dynamically change parameters affecting the ranking of video assets for presentation in the graphical user interface. In other examples, STB 201 may be configured for voice recognition such that STB 201 may be controlled with spoken utterances.

In this manner, control device 209 may include (not shown) a cursor controller, trackball, touch screen, touch pad, keyboard, and/or a key pad for activating asset manager application 205a, navigating through the graphical user interface of ranked video assets, selecting programming content, as well as performing other control functions. For instance, control device 209 may be utilized to maximize an asset manager application, navigate through displayable interfaces, specify factors and weighting for ranking video assets, or modify STB 201 parameters. Control device 209 may also include functional actuators (e.g., buttons, keys, icons, etc.), such as power on/of, play, pause, stop, fast-forward, reverse, volume up/down, channel up/down, menu, ok/enter, record, info, my content, search, edit, or exit, as well as any other suitable control trigger, such as alphanumeric buttons, shift, control, back, symbols, and the like.

Further, the control device 209 may comprise a memory (not illustrated) for storing preferences affecting the graphical user interface of ranked video assets and related content that is being viewed, which can be conveyed to STB 201 through an input interface 237. The input interface 237 may support any type of wired and/or wireless link, e.g., infrared, radio frequency (RF), BLUETOOTH, and the like. Thus, control device 209 may store user preferences with respect to ranking video assets, such as weighting for ranking factors, previous searches, recording history, programming preferences, etc. Alternatively, user preferences may be tracked, recorded, or stored in STB 201 or in a network user profile repository 121. The preferences may be automatically retrieved and activated by a user at any time. It is noted that the control device 209 may be separate from STB 201 or may be integrated within STB 201 (in which case certain input interface hardware and/or software may not be necessary).

Particular embodiments enable users, via control device 209, to populate or otherwise configure a user profile. For instance, a user profile application may be provided or accessed by STB 201 to enable users to populate a plurality of entry fields with user information. A user profile may include one or more customized or personalized settings that affect any aspect of creating a personalized graphical user interface of ranked video assets via STB 201. More specifically, the profile may include: subscription information (account number, user name, password, avatar, moniker, etc.), subscriber demographics (age, gender, ethnicity, location of residence, zip code, school district, community, socioeconomic status, religion, marital status, ownerships, languages, mobility, life cycles, etc.), group/organizational affiliations (e.g., political), memberships, interests, buddies, friends, cohorts, system configurations, policies, associated users/devices, etc., as well as any other like personal information. Additionally, a user profile may include a “whitelist” specifying one or more accessible programming content sources/subjects, a “blacklist” specifying one or more programming content sources/subjects, as well as other equivalent customized settings, such as color schemes, sound effects, etc.

In other embodiments, the user profile may be established using the additional access devices described earlier, e.g., end terminal 117, such as PC 221. As such, user profile information may be stored in STB 201, e.g., in memory 231, and/or at a user site repository (not illustrated) directly connected to STB 201. Additionally or alternatively, profile information may be stored in a network-based repository (e.g., remote user profile repository 121), control device 209, and/or any other storage medium. Similarly, STB 201 (via memory 231), a user site repository, and/or a network-based repository may store a “MY CONTENT” collection of video asset ranking information, digital audio, video and/or pictographic content accumulated by a user. This collection may also be available for ranking and presentation in the graphical user interface of ranked video assets.

Thus, under arrangements of FIGS. 1 and 2, a user may create, experience (e.g., locate, specify, and receive), as well as share (e.g., transmit) ranking information for presenting video assets in a graphical user interface. The operation of STB 201 and one or more asset manager applications 205a-205c, in conjunction with the components of system 100, are described below.

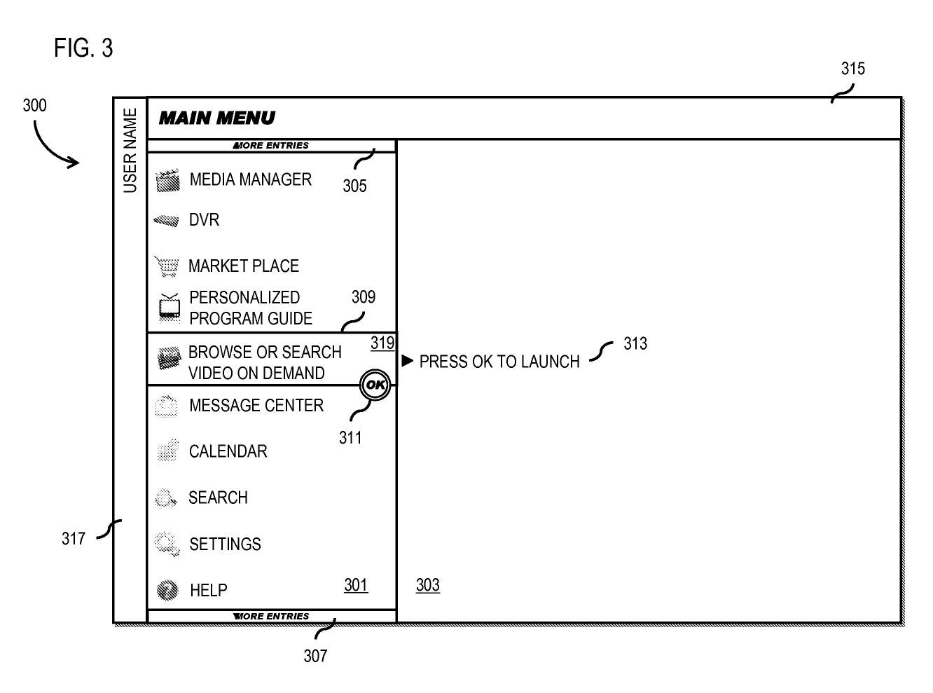

As there may be a relatively large number of programming content sources and even more content instances available to users, STB 201 may include a user interface configured to allow users to seamlessly access the functions of STB 201, video asset ranking information, related media content, and one or more of the asset manager applications 205a-205c. It is recognized; however, that the user interface may be implemented at one or more end terminals 117 (e.g., PC 221) or accessible via server 119 or programming service provider 111. Thus, the user interface may be displayed to the user as part of an asset manager application accessed over a suitable communications link. Namely, web pages may be displayed to the user as part of an online graphical user interface of ranked video assets accessed over an Internet communications link. Accordingly, FIG. 3 is a diagram of a main menu user interface of the set-top box of FIG. 2, according to an exemplary embodiment.

The main menu 300 interface may be evoked using a number of different methods. For example, the user may select a dedicated “MENU” button on control device 209 or a peripheral device communicatively coupled thereto (e.g., PC 221, a mobile handset, etc.). It is recognized that any other suitable actuator of these devices may be additionally, or alternatively, used to access the functionality of main menu 300, such as triggering a “MENU” icon. Further, main menu 300 may be evoked by selecting an option within another interface or application (e.g., when navigating from a public screen to a user-specific screen, i.e., a private screen). As such, an executing device (e.g., STB 201, PC 221, etc.) may require sufficient authentication information (e.g., username and password, etc.) to be input in order to access the functions of main menu 300.

As shown, interface (or screen) 300, providing a “Main Menu,” may include one or more interactive viewing panes, such as panes 301 and 303. In particular embodiments, the content of pane 303 may be dynamically updated to display various information related to actions conducted within pane 301, and vice versa. Pane 301 includes a listing of selectable entries corresponding to one or more features (or options) that may be provided via STB 201. For example, entries can include: program guide functions, DVR options, marketplace (shopping) options, on-demand programming options (e.g., browsing or searching on-demand programming), media manager features, messaging and communications features, searching options, settings, help features, and the like. In certain embodiments, graphical elements may be provided to correspond to one or more of the entries, and may be displayed therewith.

Header 305 and footer 307 fields may be provided and configured to indicate the existence of additional entries not displayed, but navigably available. Accordingly, users may browse through these entries via, for instance, control device 209. A fixed focus state (e.g., border 309) and/or distinctive magnification features, e.g., color, brightness, bolding, font type, text size, etc., may be used to convey a “currently” navigated position. In this manner, when a user navigates to a desired entry, actuation of, for instance, an “OK” button on control device 209 may launch corresponding features and/or applications of the particular entry. In some embodiments, an interactive “OK” option 311 may be utilized. Moreover, main menu 300 may include tooltips (e.g., tooltip 313) when a user navigates to a particular entry. In other embodiments, an aural description of the entry navigated to and methods of interaction may be provided.

In other embodiments, main menu 300 may provide navigation fields 315 and 317 to facilitate usability. For example, field 315 may provide the name of the function/option being accessed, e.g., “MAIN MENU.” In this manner, when a user accesses a new function/option, field 315 is automatically updated. Field 317 may be utilized to indicate the user profile currently authenticated to system 100, e.g., “USER NAME.” Thus, a user may access an asset manager application (e.g., asset manager application 205a) by navigating to and selecting entry 319 of main menu 300. In exemplary embodiments, one or more asset manager applications 205a-205c may be utilized to create a graphical interface of ranked video assets for presentation to a user via STB 201.

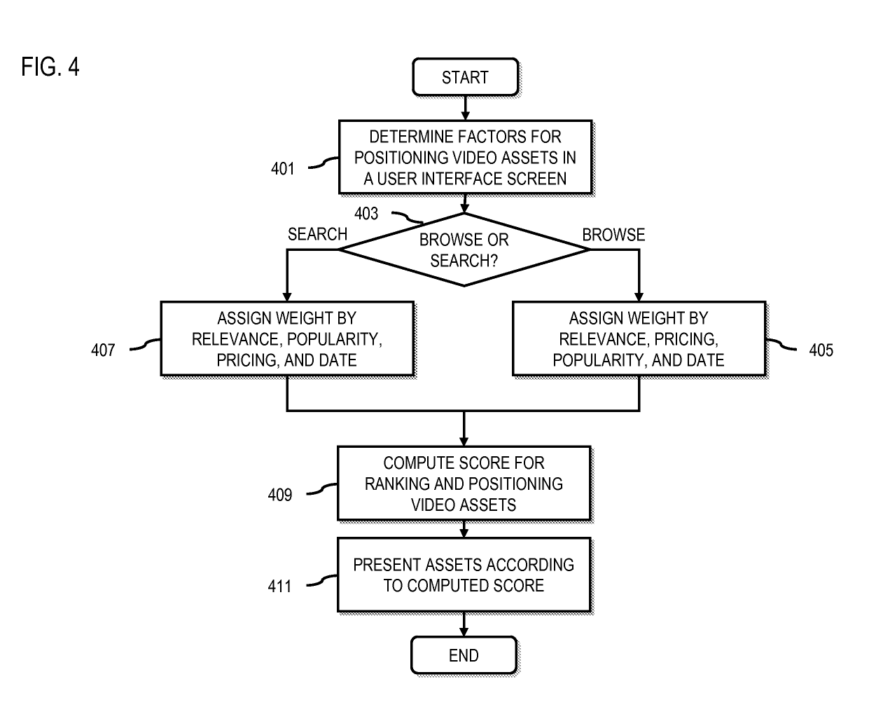

FIG. 4 is a flowchart of a process for ranking and presenting video assets, according to an exemplary embodiment. In one embodiment, the process of FIG. 4 is performed by one or more asset manager applications 115a-115c. At step 401, an asset manager 115a determines factors for positioning video assets represented on a graphical user interface. In one embodiment, there are many factors that can affect how video assets (e.g., VOD content) are positioned on graphical user interface for presentation to a user. These factors include price, relevancy, active date, popularity, etc.

For example, the programming service provider 111 may configure the asset manager 115a to present video assets with higher prices first, followed by assets with decreasing prices, and then finally with assets that are broadcast without a specific charge. The price indicates a cost to the user for viewing or accessing the video asset. The prices of video assets, for instance, are set or specified by the programming service provider 111, the content provider systems 125, and/or other similar systems. The price factor operates in conjunction with the other ranking factors to enable finer levels customization and ranking.

The relevancy factor relates to how closely a particular video asset matches browsing criteria or search criteria specified by the user. In one embodiment, the asset manager 115a conducts a key word search against the metadata associated with each video asset to determine the relevancy factor. The degree of matching between the criteria and metadata may then be normalized to a numerical value (e.g., a percentage matching such as 100% match, 75% match, etc.) based on how closely the criteria matches. It is contemplated that the asset manager 115a may employ any metric for expressing the degree of matching between the browse or search criteria and a particular video asset. In certain embodiments, the asset manager 115a may store information on the user's historical viewing habits, search history, browsing history, and the like to determine the types of programming content or video assets favored by the user. In this way, the relevance of a video asset to a particular user reflects both the search criteria as well as the historical preferences of the user. This historical information can be stored, for instance, in the user profile repository 121.

The active date specifies the dates and/or times the video asset is available. For VOD content or other on-demand content, for instance, the active date specifies the period of time during which the content can be viewed. This period of time is generally specified from a begin date (e.g., active date) and time to an end date and time (e.g., expiration date). For video assets that are traditional broadcast content, the active date can be specified as the dates and times the video asset is scheduled for broadcast.

Finally, the popularity factor is a measure of how many times the video asset has been accessed by user of the service provider network 101. In addition or alternatively, popularity can be a measure of how many recommendations or votes are received by a particular video from users or subscribers of the service provider network 101. It is contemplated that any other measure of the prevalence or favorability of a video asset within the service provider network 101 may be used as an indicator of popularity.

In one embodiment, the asset manager 115a obtains or determines the information to evaluate these factors with respect to each video asset from the metadata associated with the video assets. In addition or alternatively, the information may be specified by the service provider 111 and/or content provider systems 125. It is also contemplated that the information may be specified manually by the user. Next, the asset manager 115a determines the weighting values for each of the factors based on rules associated the particular operation (e.g., browse or search) the user has selected to perform (step 403). For example, the asset manager 115a assigns a different set of weighting values for each factor for each different operation (e.g., browse or search). Similarly, the weighting values and factors may also be customized individually and separately for each of the different operations (e.g., browse or search).

If the asset manager 115a determines that the user has performed a browse operation, the asset manager 115a specifies weighting values such that, from highest to lowest weight, the ranking factors are prioritized as follows: relevance, pricing, popularity, and date (step 405). For example, a user may browse video assets by category (e.g., action, sports, movies, etc.). Typically, the user browses when the user does not have a particular video asset in mind and wants to look at what video assets are generally available. In one embodiment, the weighting values of the browse operation is assigned as follows: (1) relevancy factor, e.g., this is a prerequisite factor in that the video assets belong to the category the user is browsing; (2) price factor, e.g., is weighted at 50% of the overall ranking score; (3) popularity factor, e.g., is weighted at 30% of the overall ranking score; and (4) active date factor, e.g., is weighted at 20% of the overall ranking score.

If the asset manager 115a determines that the user has performed a search operation, the asset manager 115a specifies weighting values such that, from highest to lowest weight, the factors are prioritized as follows: relevance, popularity, pricing, and date (step 407). It is noted that, in comparison, to the weighting values for the browse operation, the priority of the factors for the search operation reverses the relative priorities of the popularity and pricing factors. This is because, typically, a user who performs a search operation knows what the user is looking for. Accordingly, price may not be as important a factor as popularity in this context. In one embodiment, the weighting of the factors reflect this difference by assigning weighting values for the search operation as follows: (1) relevancy factor, e.g., is weighted at 50% of the overall ranking score; (2) popularity factor, e.g., is weighted at 25% of the overall ranking score; (3) price factor, e.g., is weighted at 15% of the overall ranking score; and (4) active date factor, e.g., is weighted at 10% of the overall ranking score.

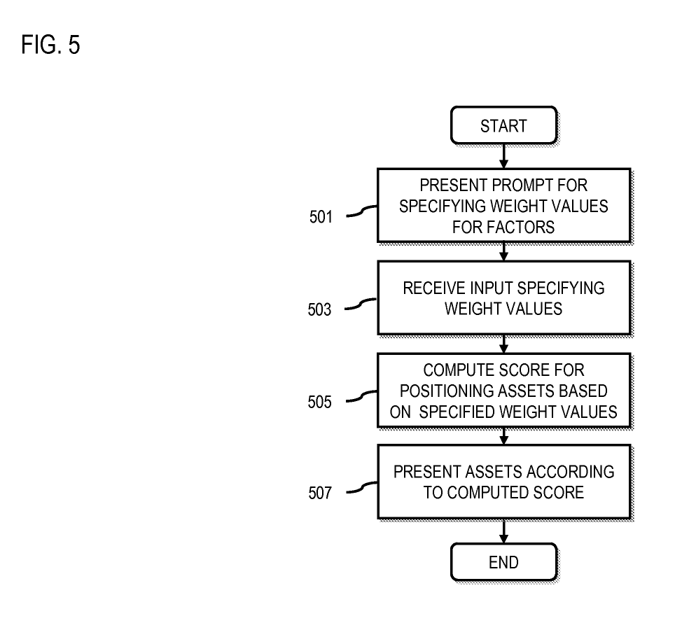

It is contemplated that additional operations besides browse and search (e.g., index, update, etc.) may be added and that each operation may be assigned a different set of factors and corresponding weighting values. Moreover, as described in more detail with respect to FIG. 5, the asset manager 115a enables the user to change or define what factors to use for determining the ranking for the video assets and to define what weighting to apply to each factor.

After determining the factors and the weighting values, the asset manager 115a computes a score for ranking each of the available video assets with respect to the positioning of other ones of the video assets (step 409). In one embodiment, the ranking score for each video asset is computed as follows:

ranking score=(w1×relevance)+(w2×popularity)+(w3×price)+(w4×active date)
where w1=weighting for relevance, w2=weighting for popularity, w3=weighting for price, and w4=weighting for active date.

The asset manager 115a then uses the computed ranking scores to establish a positioning or order for presenting the video assets in a graphical user interface. The asset manager 115a presents the video assets in the graphical user interface to the user according to the determined positioning (step 411). For example, if the graphical user interface presents video assets as a list, the asset manager 115a can display the most highly ranked video asset in the first position of the list, with each subsequent entry in the list consisting of the next most highly ranked video asset up to a predetermined number of entries or until the available video assets are exhausted. In another embodiment, the asset manager 115a may display the most highly ranked video assets in a larger font or typeface with each subsequently ranked video asset rendered in a decreasing font size. It is contemplated that the asset manager may use any user interface representation to indicate the relative rankings of the video assets.

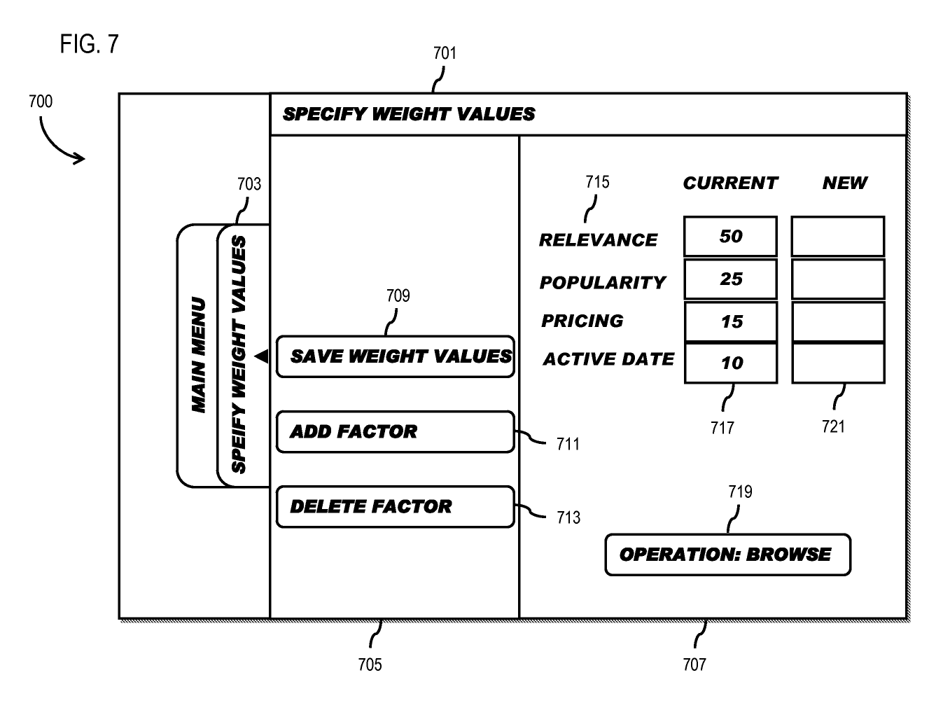

FIG. 5 is a flowchart of a process for presenting video assets based on user-specified weighting values, according to an exemplary embodiment. In one embodiment, the process of FIG. 4 is performed by one or more asset manager applications 115a-115c. At step 501, the asset manager 115a presents a prompt to the user for specifying weighting values for the set of factors used for ranking the video assets. As described above, these factors include relevance, popularity, pricing, and active date. It is contemplated that any of the service provider 111, content provider systems 125, and/or the user may specify additional or replacement factors. In response to the prompt, the asset manager 115a receives input from the user for specifying the weighting values. Additionally, the prompt for weighting values may be initiated automatically by the asset manager 115a or other component of the service provider network 101, or may be initiated manually by the user. An example of a user input screen for weighting values is described with respect to FIG. 7 below.

In one embodiment, the asset manager 115a receives the input as a percent value indicating the percentage that each factor contributes to the overall ranking score (step 503). The asset manager may also validate responses to ensure that all the weighting factors add up to a full 100%. If not, the asset manager 115a may prompt the user to correct the input. In addition or alternatively, the asset manager 115a may suggest weighting values based on the user input to add up to the full 100%. In other embodiments, the asset manager 115a need not use percent values, and instead, may use any system (e.g., predetermined weighting units) to indicate the relative weights of the factors.

On receipt of the weighting values, the asset manager may compute the ranking scores for the available video assets based on the new values (step 505) and then present a graphical user interface with the video assets positioned according to the new rankings (step 507). In certain embodiments, steps 505 and 507 need not be performed immediately following the designation of the new weighting values. Instead, the asset manager 115a may store the values for later use.

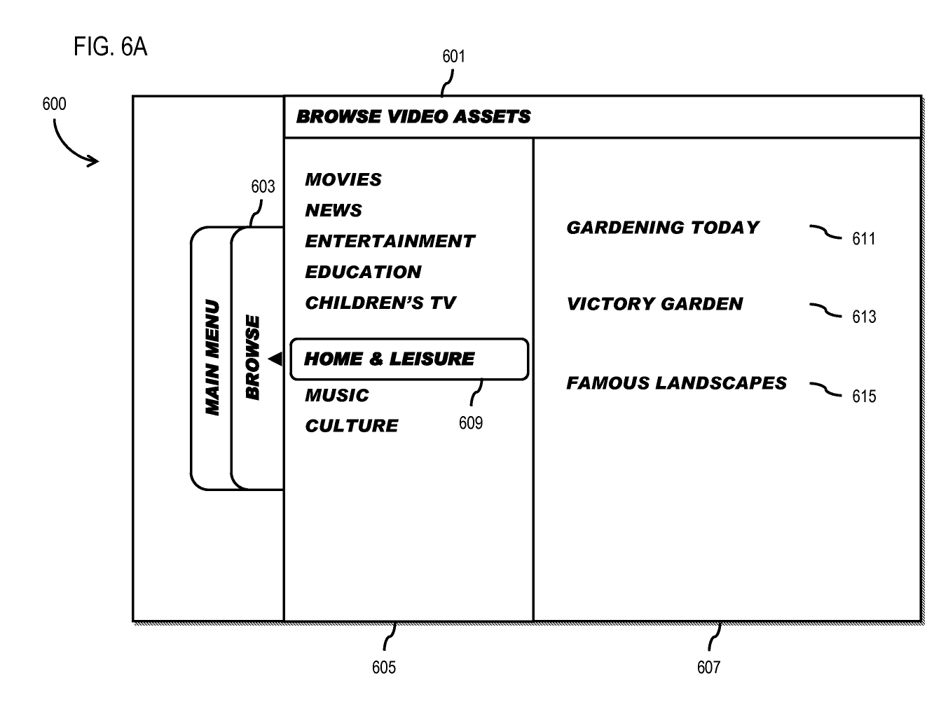

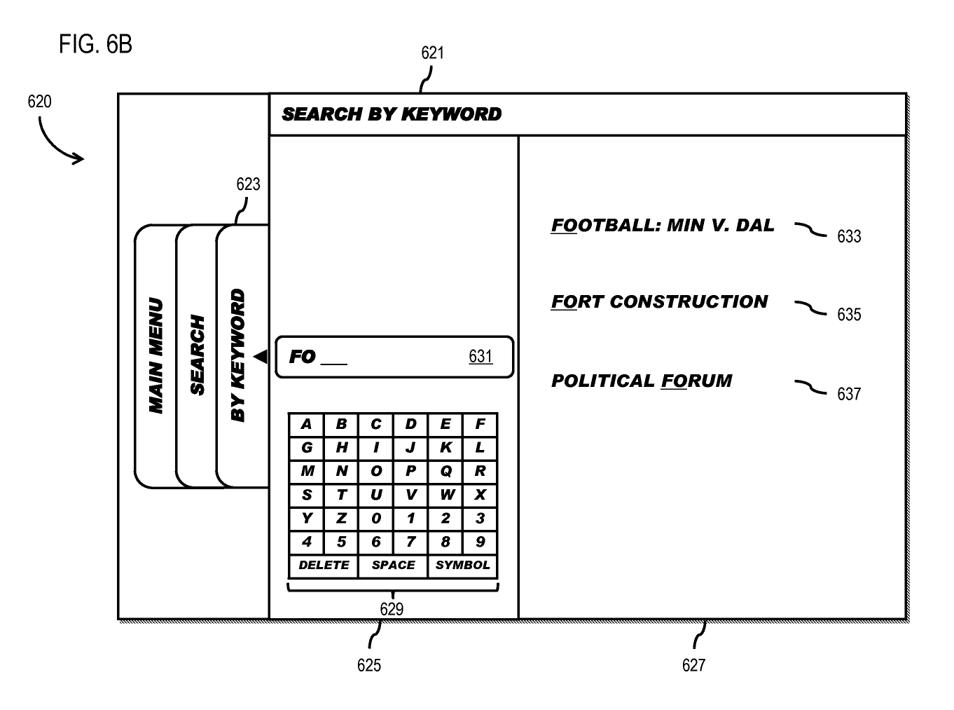

FIGS. 6A and 6B are diagrams of user interfaces utilized in the processes of FIGS. 4-5, according to various embodiments. As shown in FIG. 6A, the asset manager 115a presents a user interface 600 to display ranked video assets based on a browsing operation. Although the user interface 600 illustrates a browsing operation based on browsing by genre, it is contemplated that the system 100 enables browsing by any number of categorization (e.g., actors, directors, year, language, etc.). To assist the user in navigating, the user interface 600 identifies the current operation (e.g., “Browse Video Assets”) in a heading 601 as well as in a tab 603. Additionally, the interface 600 is divided into a video genre pane 605 and a results pane 607. By way of example, the video genre pane 605 lists genres of the video assets available for browsing. As depicted, the genres include movies, news, entertainment, education, children's television, home & leisure, music, and culture.

The user may select any genre to browse by highlighting the desired genre using the highlight box 609. For example, the user my make the selection using the control device 209 or other similar device to navigate the selections. On making the selection, the asset manager 115a performs the process 400 of FIG. 4 to compute ranking scores for each of the video assets that match the selected genre (e.g., are in the specified genre). In this case, the user has selected the “home & leisure” genre. Based on this selection, the asset manager 115a filters for the video assets in the selected genre and displays matching video assets in a list according to the computed ranking scores for each video asset. In this example, the results pane 607 lists three video assets (e.g., video assets 611-615) that match the genre. By way of example, the video asset 611, “Gardening Today,” is the most highly ranked program based on the computed factors of relevance, pricing, popularity, and active date. In other words, the program is highly relevant because it matches the genre, is priced in a way that most closely matches the service provider's 111 criteria (e.g., highest priced assets should be listed first), is popular with other viewers, and is currently active and available for viewing. The other two video assets 613 and 615 are listed according to their respective rankings.

FIG. 6B depicts a user interface 620 that enables searching for video assets by keywords. Like the user interface 600 of FIG. 6A, the user interface 620 includes a heading 621 and a tab 623 to identify the current operation to facilitate user navigation. The user interface 620 also includes a search input pane 625 and a results pane 627. The user can input keyword searches in the search pane 625 using, for instance, the soft keyboard 629 with the user's typed entry appearing in the input area 631. As the user types, the asset manager 115a dynamically computes the ranking scores for video assets that match the user's search.

For example, as shown in FIG. 6B, the user has typed the letters “FO” in the input area 631. In response, the asset manager 115a searches for video assets that include the letters typed thus far. As the user continues typing, the search is further refined and repeated. In this case, video assets 633-637 meet the search criteria in that they contain the at least the letters “FO.” The asset manager computes the ranking score of the three video assets 633-637 and determines that video asset 633, “Football: Min v. Dal,” is the most highly ranked of the three video assets 633-637. Accordingly, the asset manager 115a displays the asset first in the results pane 627. For example, the asset manager 115a can evaluate the user's past viewing history to infer that this particular user has often watched football games, particularly when Minnesota is playing. Accordingly, even though the user has input only two letters (e.g., “FO”), the asset manager 115a computes a high ranking for the video asset 633 relative to the other two assets 635 and 637 because of the user's past history with football.

FIG. 7 depicts a user interface for specifying factors and weighting values for ranking video assets, according to an exemplary embodiment. As discussed previously, the asset manager 115a enables the user to customize the factors and weighting values that the manager 115a uses to ranking video assets for presentation in a graphical user interface. In one embodiment, the user interface 700 provides access for the user to perform this function. By way of example, the user interface 700 includes a heading 701 and a tab 703 to indicate that the user interface 700 is for specifying factors and/or corresponding weighting values. In addition, the user interface 700 includes a command pane 705 and an input pane 707 for managing weighting values. As shown, the command pane 705 includes options to activate commands related to setting weighting values including, for instance, a command 709 to set weighting values, a command 711 to add a ranking factor, and a command 713 to delete a ranking factor. These commands operate on the set of factors 715, current weighting values 717, and operational command 719 displayed in the input pane 707.

As discussed previously, the factors 715 and weighting values 717 may be specified separately for each operation (e.g., browse or search) available to view and/or manage video assets. The input pane 707 lists the current set of factors 715 (e.g., relevance, popularity, pricing, active date) and weighting values 717 currently in use by the asset manager 115. The user may input customized weighting values in the new value input fields 721. For example, to customized weighting values, the user may input the values in the input fields 721 and then select the save weight values command 709 to save the values. The user may also select the operation option 719 to change the operational command currently displayed in the input pane 707. For instance, to display the set of factors 715 and weighting values 717 applicable to the search operation instead of the browse operation, the user selects the operation option 719 to toggle between other available operational commands, factors, and weighting values. In this way, the user may customize the factors for ranking video assets on an operation-by-operation basis.

One of ordinary skill in the art would recognize that the processes described above may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

FIG. 8 illustrates computing hardware (e.g., computer system) upon which an embodiment according to the invention can be implemented. The computer system 800 includes a bus 801 or other communication mechanism for communicating information and a processor 803 coupled to the bus 801 for processing information. The computer system 800 also includes main memory 805, such as random access memory (RAM) or other dynamic storage device, coupled to the bus 801 for storing information and instructions to be executed by the processor 803. Main memory 805 also can be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for controlling cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Model (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 8, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to non-volatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
determining a plurality of factors for positioning of video assets represented on a graphical user interface;
determining weighting of the factors using one or more rules that are based on a search operation or a browse operation relating to the assets; and
computing a score for ranking of a particular one of the assets with respect to the positioning of other ones of the assets based on the determined weighting of the factors.

2. A method of claim 1, further comprising:
presenting the particular asset on the graphical user interface based on the computed score.

3. A method of claim 1, wherein the factors include pricing, relevancy, active date, popularity, or a combination thereof.

4. A method of claim 3, wherein the rule is based on the search operation, the method further comprising:
assigning high to low weight values according to the relevance, the popularity, the pricing, and the active date,
wherein the score is computed based on the assigned weight values.

5. A method of claim 3, wherein the rule is based on the browsing operation, the method further comprising:
assigning high to low weight values according to the relevance, the pricing, the popularity, and the active date,
wherein the score is computed based on the assigned weight values.

6. A method of claim 3, wherein a user specifies weight values for the factors.

7. A method of claim 1, further comprising:
presenting the graphical user interface on a display.

8. A method of claim 1, wherein the video assets include video-on-demand assets.

9. A set-top box apparatus comprising:
a controller configured to determine a plurality of factors for positioning of video assets represented on a graphical user interface, determine weighting of the factors using one or more rules that are based on a search operation or a browse operation relating to the assets, and compute a score for ranking of a particular one of the assets with respect to the positioning of other ones of the assets based on the determined weighting of the factors.

10. An apparatus of claim 9, further comprising:
a presentation module configured to present the particular asset on the graphical user interface based on the computed score.

11. An apparatus of claim 9, wherein the factors include pricing, relevancy, active date, popularity, or a combination thereof.

12. An apparatus of claim 11, wherein the rule is based on the search operation, and the controller is further configured to assign high to low weight values according to the relevance, the popularity, the pricing, and the active date,
the score being computed based on the assigned weight values.

13. An apparatus of claim 11, wherein the rule is based on the browsing operation, and the controller is further configured to assign high to low weight values according to the relevance, the popularity, the pricing, and the active date,
the score being computed based on the assigned weight values.

14. An apparatus of claim 11, wherein a user specifies weight values for the factors.

15. An apparatus of claim 9, further comprising:
a presentation module configured to present the graphical user interface on a display.

16. An apparatus of claim 9, wherein the video assets include video-on-demand assets.

17. A system comprising:
an asset manager configured to determine a plurality of factors for positioning of video assets represented on a graphical user interface, determine weighting of the factors using one or more rules that are based on a search operation or a browse operation relating to the assets, and compute a score for ranking of a particular one of the assets with respect to the positioning of other ones of the assets,
wherein the asset manager is coupled to a multimedia system with connectivity to a plurality of sources of the video assets and to a plurality of set-top boxes, and
wherein the factors include pricing, relevancy, active date, popularity, or a combination thereof.

18. A system of claim 17, wherein the asset manager is further configured to initiate presentation of the particular asset on the graphical user interface based on the computed score.

19. A system of claim 17, wherein the rule is based on the search operation, and the asset manager is further configured to assign high to low weight values according to the relevance, the popularity, the pricing, and the active date,
the score being computed based on the assigned weight values.

20. A system of claim 17, wherein the rule is based on the browsing operation, and the asset manager is further configured to assign high to low weight values according to the relevance, the popularity, the pricing, and the active date,
the score being computed based on the assigned weight values.
